(19) United States
(12) Patent Application Publication
(10) Pub. No.: US 2025/0389420 A1
(43) Pub. Date: Dec. 25, 2025

(54) COMBUSTOR AND POWER GENERATOR INCLUDING THE SAME

(71) Applicant: DOOSAN ENERBILITY CO, LTD., Changwon-si (KR)

(72) Inventor: Sunghoon KIM, Gyeongsangnam-do (KR)

(21) Appl. No.: 19/242,668

(22) Filed: Jun. 18, 2025

(30) Foreign Application Priority Data
Jun. 25, 2024 (KR) 10-2024-0083041

(51) Int. Cl. F23R 3/28; F23D 14/48; H02K 7/18

(52) U.S. Cl. CPC F23R 3/283; F23D 14/48; H02K 7/1823; F23D 2214/00; F23R 2900/03041

(57) ABSTRACT

Disclosed is a combustor including a nozzle that generates flames, an effusion plate, in which at least a portion of the nozzle is accommodated, and a stiffener coupled to the effusion plate to change a natural frequency of the effusion plate.

### CROSS-REFERENCE TO RELATED APPLICATION

This application claims the benefit of priority to Korean Patent Application No. 10-2024-0083041, filed in the Korean Intellectual Property Office on Jun. 25, 2024, the entire contents of which are incorporated herein by reference.

### TECHNICAL FIELD

The present disclosure relates to a combustor and a power generator including the same. More particularly, the present disclosure relates to a combustor that is configured to reinforce a stiffness of an effusion plate, and a power generator including the same.

### BACKGROUND

A gas turbine is a power engine that mixes compressed air that is compressed in a compressor, burns the mixture with fuel, and rotates a turbine with a high-temperature gas generated through combustion. Gas turbines are used to drive power generators, aircrafts, ships, trains, and the like.

In general, a gas turbine includes a compressor, a combustor and a turbine. The compressor suctions exterior air, compresses it, and then delivers it to the combustor. The air compressed by the compressor becomes a high pressure and a high temperature. The combustor burns a mixture of the compressed air introduced from the compressor and the fuel. The combustion gas generated through combustion is discharged to the turbine. The turbine blade in an interior portion of the turbine is rotated by the combustion gas, causing the generation of power. The generated power is used in various fields, such as power generation and driving of mechanical devices.

The fuel is injected through nozzles installed in respective combustors, and the nozzles may inject gaseous fuel and liquid fuel. When the injected fuel is ignited, the combustor may deliver the burned air to the turbine. As air is burned, vibration due to flames may be generated, and the flame vibration may be transmitted to the effusion plate, on which the nozzles are mounted. In this case, when the frequency of the flame vibration coincides with the natural frequency of the effusion plate, the possibility of damage to the effusion plate may occur.

When the effusion plate is damaged, the damaged piece of the effusion plate may cause damage to other components while moving in an interior of the combustor or the power generator, and the combustor, in which the corresponding effusion plate is located, has to be stopped to replace the damaged effusion plate, and thus, the electricity supply efficiency of the power generator may be affected.

### SUMMARY

The present disclosure has been made to solve the above-mentioned problems occurring in the prior art while advantages achieved by the prior art are maintained intact.

An aspect of the present disclosure provides a combustor that is configured to avoid a natural frequency of an effusion plate, and a power generator including the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a combustor includes a nozzle that generates flames, an effusion plate, in which at least a portion of the nozzle is accommodated, and a stiffener coupled to the effusion plate to change a natural frequency of the effusion plate.

A nozzle opening configured such that the nozzle may be inserted thereinto may be formed in the effusion plate, and the stiffener may be located adjacent to the nozzle opening.

A plurality of nozzle openings may be provided, and the stiffeners may be located between the plurality of nozzle openings.

The plurality of nozzle openings may include peripheral nozzle openings arranged in a circumferential direction, and the stiffeners may be located between the peripheral nozzle openings.

The effusion plate may include a vulnerable part located between the plurality of nozzle openings, and the stiffener may be located to overlap a portion of the vulnerable part, which has the smallest width, to increase a stiffness of the effusion plate.

The effusion plate may include a plate part, in which the nozzle opening may be formed, and a nozzle guide protruding from the nozzle opening in a direction becoming more distant from the nozzle opening to guide insertion of the nozzle, the nozzle guide may be formed to be bent from the plate part while having a curvature, and the stiffener may be coupled to the plate part to prevent from overlapping a portion of the nozzle guide, which has the curvature.

A plurality of cooling holes formed such that cooling air flows therethrough may be formed in the effusion plate, and the stiffener may prevent the plurality of cooling holes from being covered.

A stiffener hole may be formed in the stiffener, and the stiffener hole may be located to communicate with the cooling hole.

The stiffener may have a side surface facing the nozzle opening and having a curvature corresponding to a curvature of a periphery of the nozzle opening.

The stiffener may protrude from the effusion plate while having a spacing hole between the effusion plate and the stiffener to emit heat of the effusion plate.

The stiffener may protrude longer than a thickness of the effusion plate.

The stiffener may include a first stiffener part extending in a first direction, and a second stiffener part extending from the first stiffener part and extending in a second direction being different from the first direction.

The stiffener may be located between the nozzles and is coupled to a portion of the effusion plate, which has a higher temperature than that of a surrounding.

The plurality of nozzle openings may include peripheral nozzle openings arranged in a circumferential direction, and a central nozzle opening surrounded by the peripheral nozzle openings, and the stiffener may be located such that at least a portion thereof overlaps an area obtained by connecting centers of the peripheral nozzle openings and the central nozzle opening.

The nozzle may generate the flames on one side of the effusion plate, and the stiffener may be located on an opposite side of the effusion plate, which is opposite to the one side.

According to another aspect of the present disclosure, a power generator includes a combustor, and a turbine that generates electricity by a gas burned in the combustor, and the combustor may include a nozzle that generates flames, an effusion plate, on which the nozzle is mounted, and a stiffener coupled to the effusion plate to change a natural frequency of the effusion plate.

A nozzle opening configured such that the nozzle is inserted thereinto may be formed in the effusion plate, and the stiffener may be located adjacent to the nozzle opening.

A plurality of nozzle openings may be provided, and the stiffeners may be located between the plurality of nozzle openings.

The plurality of nozzle openings may include peripheral nozzle openings arranged in a circumferential direction, and the stiffeners may be located between the peripheral nozzle openings.

According to another aspect of the present disclosure, a combustor includes a nozzle housing defining an air chamber, into which air is introduced from a compressor, and in which a nozzle is accommodated, a combustor housing defining a combustion chamber, in which a combustion reaction occurs, an effusion plate dividing the air chamber and the combustion chamber, and a stiffener coupled to the effusion plate to change a natural frequency of the effusion plate.

### BRIEF DESCRIPTION OF THE DRAWINGS

The above and other objects, features and advantages of the present disclosure will be more apparent from the following detailed description taken in conjunction with the accompanying drawings:

FIG. 1 is a power generator according to a first aspect of the present disclosure;

FIG. 2 is a cross-sectional view of a combustor illustrated in FIG. 1;

FIG. 3 is a plan view as viewed from a rear side of a effusion plate and a stiffener illustrated in FIG. 1;

FIG. 4 is an enlarged plan view illustrating an effusion plate and a stiffener illustrated in FIG. 3, focusing on the stiffener;

FIG. 5 is a cross-sectional view, taken along line V-V′ illustrated in FIG. 4;

FIG. 6 is a plan view as viewed from a rear side of an effusion plate and a stiffener according to a second aspect of the present disclosure;

FIG. 7 is an enlarged plan view illustrating an effusion plate and a stiffener illustrated in FIG. 6, focusing on the stiffener;

FIG. 8 is a cross-sectional view taken along line VII-VIII′ illustrated in FIG. 7;

FIG. 9 is a longitudinal cross-sectional view of a part of an effusion plate and a stiffener according to a third aspect of the present disclosure; and

FIG. 10 is a longitudinal cross-sectional view of a part of an effusion plate and a stiffener according to a fourth aspect of the present disclosure.

### DETAILED DESCRIPTION

Hereinafter, aspects of the present disclosure will be described in detail with reference to the accompanying drawings so that those skilled in the art may easily carry out the present disclosure. However, the present disclosure may be implemented in several different forms, and is neither limited nor limited by the following aspects.

To clearly explain the present disclosure, a detailed description of parts that are not related to the description or related known technologies that may unnecessarily obscure the gist of the present disclosure will be omitted, and when adding reference numerals to components of each drawing in the specification, the same or similar reference numerals are attached throughout the specification.

In addition, terms or words used in the specification and claims should not be interpreted as being limited to ordinary or dictionary meanings, and should be interpreted as meanings and concepts that are consistent with the technical idea of this present disclosure based on the principle that the inventor may properly define the concepts of the terms to explain aspects provided herein in the best way.

Various aspects of the present disclosure and terms used herein are not intended to limit the technical features described in the present disclosure to specific aspects, and it should be understood that the aspects and the terms include modification, equivalent, or alternative on the corresponding aspects described herein.

With regard to description of drawings, similar or related components may be marked by similar reference marks/numerals.

The singular form of the noun corresponding to an item may include one or more of items, unless interpreted otherwise in context.

In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

The term “and/or” includes a combination of a plurality of related described components or any one of a plurality of related described components.

The terms, such as “first” or “second” may be used to simply distinguish the corresponding component from the other component, but do not limit the corresponding components in other aspects (e.g., importance or order).

When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

When a component is “connected,” “combined,” “support” or “in contact” with another component, this includes not only when the components are directly connected, combined, supported, or in contact, but also the components are indirectly connected, combined, supported, or in contact, through a third component.

When a component is located “on” another component, this includes not only when one component is in contact with another component, but also when another component exists between the two components.

On the other hand, the terms an “upward/downward direction”, a “lower side”, and a “forward/rearward direction” used in the following description are defined based on the drawing, and the shape and position of each component are not limited by the terms.

Hereinafter, aspects of the present disclosure will be described in detail with reference to the accompanying drawings.

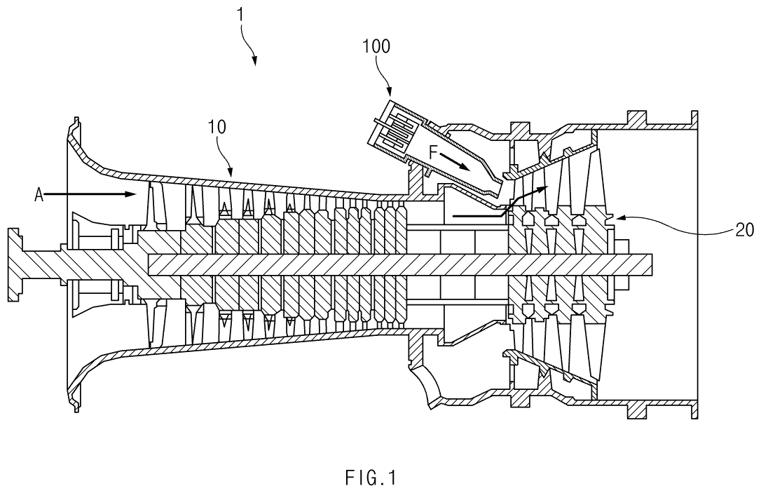

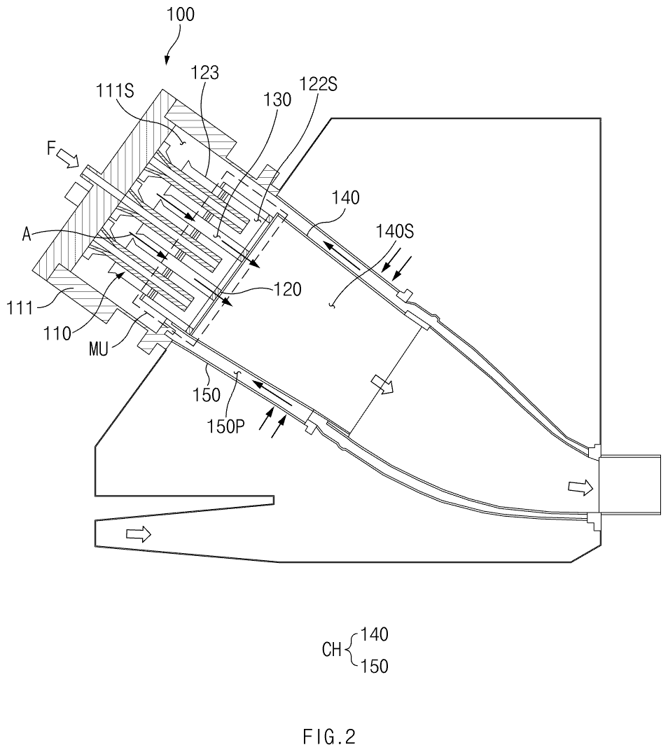

FIG. 1 is a cross-sectional view of a power generator 1 according to a first aspect of the present disclosure FIG. 2 is a cross-sectional view of a combustor 100 illustrated in FIG. 1.

Referring to FIGS. 1 and 2, the power generator 1 and the combustor 100 according to a first aspect of the present disclosure will be described.

The power generator 1 may be provided to generate electricity. The power generator 1 may obtain electricity through combustion of gas, and thus may be referred to as a gas turbine 20. A thermodynamic cycle of the power generator 1 may ideally follow a Brayton cycle. The Brayton cycle may include four processes that lead to isotropic compression (insulation compression), static-pressure heat feeding, isotropic expansion (insulation expansion), and static pressure dissipation. That is, after air “A” in the atmosphere is suctioned and compressed at a high pressure, a fuel “F” is burned in a static pressure environment to emit thermal energy, and after this high-temperature combustion gas is expanded to convert it into kinetic energy, exhaust gas containing residual energy may be emitted into the atmosphere. That is, the cycle may include four processes: compression, heating, expansion, and heat dissipation.

The power generator 1, which operates based on the Brayton cycle as described above, may include a compressor 10, a combustor 100, and a turbine 20, as illustrated in FIG. 1. Although FIG. 1 will be referenced for the following description, a description of aspects of the present disclosure may be widely applied to a turbine engine having a configuration that is equivalent to that of the power generator 1 illustrated in FIG. 1.

Referring to FIG. 1, the compressor 10 of the power generator 1 may suction air “A” from the outside and compress the air “A”. The compressor 10 may supply compressed air “A” compressed by the compressor blade 11 to the combustor 100, and may supply the cooling air “A” to a high-temperature area that requires cooling in the power generator 1. In this case, because the suctioned air “A” goes through an adiabatic compression process in the compressor 10, the pressure and temperature of the air “A” that has passed through the compressor 10 rise.

The compressor 10 is designed as a centrifugal compressor 10 or an axial compressor 10, and the centrifugal compressor 10 is applied to a small power generator 1, whereas a large power generator 1 as illustrated in FIG. 1 has to compress a large amount of air “A”, so it is common to apply a multi-stage axial compressor 10 thereto. In this case, in the multi-stage axial compressor 10, a compressor blade 11 of the compressor 10 is rotated as a rotor disk is rotated to compress the introduced air “A” and moves the compressed air “A” to a rear end thereof. The air “A” is increasingly compressed at higher pressures while passing through the compressor blade 11 formed in multiple stages.

The compressor 10 may be driven by using a portion of power that is output from the turbine 20. To this end, as illustrated in FIG. 1, a rotary shaft of the compressor 10 and a rotary shaft of the turbine 20 may be directly connected to each other.

In the large power generator 1, almost half of the output produced by the turbine 20 may be consumed to drive the compressor 10. Accordingly, improving the efficiency of the compressor 10 directly corresponds to improving an overall efficiency of the power generator 1.

The turbine 20 may generate electricity by the gas burned in the combustor 100. The gas that flows in an interior of the turbine 20 may generate electricity by rotating the turbine blade 21.

The combustor 100 may generate high-energy combustion gas by mixing compressed air “A” supplied from an exit of the compressor 10 with the fuel “F” and performing isostatic combustion. As illustrated in FIG. 2, the combustor 100 may include a nozzle 110, a nozzle housing 111, a mount unit MU, and/or a combustor housing CH.

The nozzle housing 111 may accommodate the nozzle 110 while surrounding the nozzle 110, and may have a substantially circular cylindrical shape. The nozzle 110 may be disposed on a downstream side of the compressor 10, and may be disposed along the nozzle housing 111 that forms an annular shape. In the nozzle 110, the fuel “F” and the air “A” are mixed at an appropriate ratio and then injected to form a state that is suitable for combustion. That is, the nozzle 110 may be configured to generate flames. Furthermore, the nozzle housing 111 may define an air chamber 111S that is configured such that the air “A” is introduced thereinto. More specifically, as will be described later, the air “A” that flows from the compressor 10 along an outer surface of the combustor housing CH may be introduced into the air chamber 111S of the nozzle housing 111. The air “A” introduced into the air chamber 111S may be supplied to the nozzle 110 and mixed with the air “A” so that the nozzle 110 generates flames. Furthermore, the air “A” introduced into the air chamber 111S may flow toward an effusion plate 120, which will be described later, located on a downstream side of the air chamber 111S to cool the effusion plate 120. More specifically, the combustor housing CH may include an inner housing 140 and an outer housing 150. An air passage 150P, through which the air passes, may be formed between the inner housing 140 and the outer housing 150.

To burn the gas, a combustion chamber 140S configured to cause a combustion reaction may be formed inside the combustor housing CH. Furthermore, the combustor housing CH may connect the nozzle 110 and the turbine 20 to deliver the gas burned by the nozzle 110 to the turbine 20. The combustor housing CH may connect the nozzle 110 and the turbine 20 such that high-temperature combustion gas flows, the compressed air “A” may flow along an outer surface of the combustor housing CH to be supplied to the nozzle 110, and in the process, the combustor housing CH heated by the high-temperature combustion gas may be cooled appropriately.

In this case, an effusion plate 120 may be provided inside the nozzle housing 111 to accommodate at least a portion of the nozzle 110. The effusion plate 120 may be configured to distinguish the air chamber 111S, into which air “A” is introduced from the compressor 10, and the combustion chamber 140S, in which a combustion reaction occurs. Accordingly, the effusion plate 120 may prevent the flames generated in the combustion chamber 140S from being introduced into the air chamber 111S, and thus, may prevent damage to the components provided in the air chamber 111S, such as the nozzle 110. For reference, although a plate is included in the name of the effusion plate 120, it is not necessarily limited to the plate shape, and it may be an effusion plate 120 regardless of the shape as long as its configuration may distinguish the air chamber 111S and the combustion chamber 140S.

In this case, the flames generated in the combustion chamber 140S may generate flame vibration. When the flame vibration is transmitted to the effusion plate 120, fatigue may occur in the effusion plate 120, and cracks may occur due to the fatigue. Furthermore, when repetitive impacts occur in the effusion plate 120, and the impacts are similar to the natural frequency of the effusion plate 120, resonance may occur, resulting in damage to the effusion plate 120. When the effusion plate 120 is damaged, the function of the effusion plate 120 is degraded, and when a piece is generated in the effusion plate 120 due to the damage of the effusion plate 120, the piece of the effusion plate 120 may collide with other components of the power generator 1 to break the power generator 1. Furthermore, when the effusion plate 120 is damaged, it is necessary to replace it and the use of the combustor 100, to which the effusion plate 120 is coupled, is stopped during the replacement time, and thus, problems may occur in electricity production. The following ideas may be provided to solve the above problems.

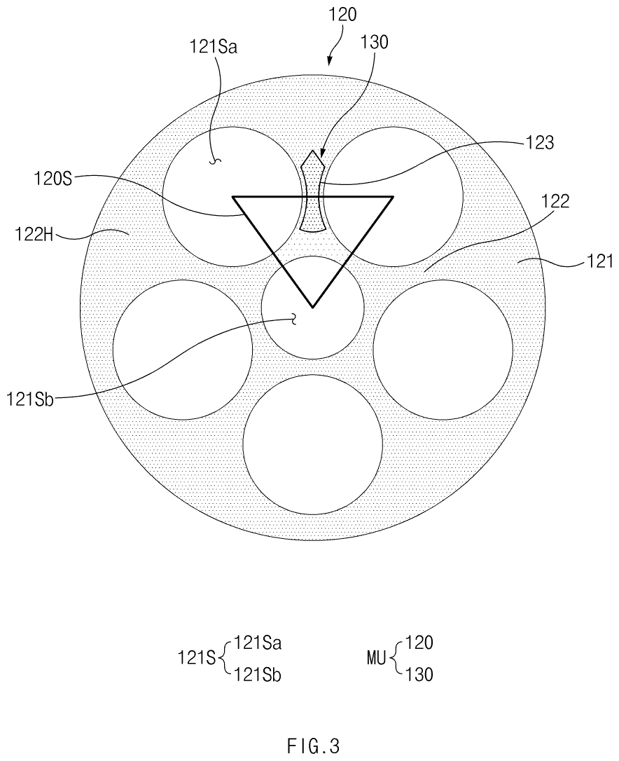

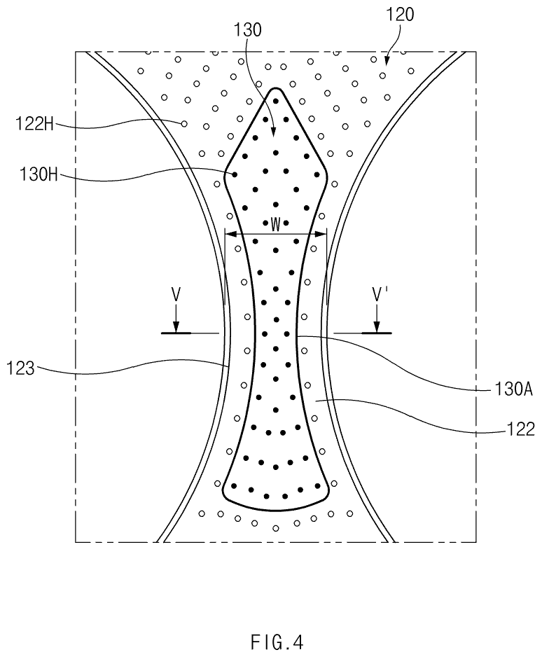

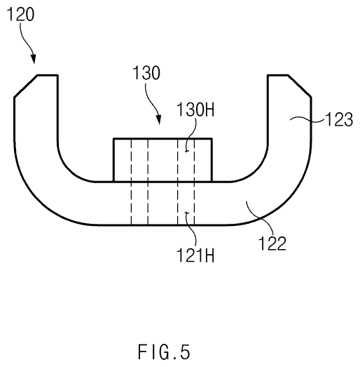

FIG. 3 is a plan view as viewed from a rear side of the effusion plate 120 and a stiffener 130 illustrated in FIG. 1. FIG. 4 is an enlarged plan view illustrating the effusion plate 120 and the stiffener 130 illustrated in FIG. 3, focusing on the stiffener. FIG. 5 is a cross-sectional view, taken along line V-V′ illustrated in FIG. 4.

Referring to FIGS. 3 to 5, the effusion plate 120 and the stiffener 130 according to a first aspect of the present disclosure will be described.

As illustrated in FIGS. 2 and 3, the effusion plate 120 and the stiffener 130 may be collectively referred to as a mount unit MU. The mount unit MU may be located between the air chamber 111S and the combustion chamber 140S. The stiffener 130 coupled to the effusion plate 120 may be provided on one side of the effusion plate 120. A total thickness of the effusion plate 120 and the stiffener 130 may be greater than the thickness of only the effusion plate 120. Furthermore, a total mass of the effusion plate 120 and the stiffener 130 may be larger than the mass of only the effusion plate 120. Accordingly, the natural frequency of the effusion plate 120 may become lower than in the case, in which the effusion plate 120 is not coupled to the stiffener 130. In other words, the natural frequency of the mount unit MU may be lower than in the case in which there is only the effusion plate 120. In general, the frequency of flame vibration may be a high frequency in many cases. Accordingly, the natural frequency of the mount unit MU may be formed while avoiding the frequency by the flame vibration by lowering the natural frequency, and thus, the mount unit MU may avoid resonance with the flame vibration. For reference, flame vibration is suggested as one possible cause of the vibration transmitted to the mount unit (MU); however, the vibration transmitted to the MU may instead result from the transmission of vibration generated by another component. The stiffener 130 may be provided to avoid resonance of such vibration. Furthermore, because the stiffener 130 supports the effusion plate 120, the stiffener 130 may increase the stiffness of the effusion plate 120.

In this case, the stiffener 130 illustrated in FIG. 3 is expressed as being single, but a plurality of stiffeners 130 may be provided. The stiffeners 130 may be attached to a plurality of parts of the effusion plate 120, which are required to change the natural frequency or to supplement the stiffness, respectively.

A nozzle opening 121S is configured such that the nozzle 110 is inserted thereinto may be formed in the effusion plate 120. As illustrated in FIG. 3, the nozzle opening 121S may be formed to have a circular cross section. However, aspects of the present disclosure are not limited thereto, and the nozzle opening 121S may have a polygonal cross section other than a circular shape. The plurality of nozzle openings 121S may include peripheral nozzle openings 121Sa that are arranged in a circumferential direction. A plurality of peripheral nozzle opening 121Sa may be provided, and five peripheral nozzle openings 121Sa may be provided as illustrated in FIG. 3. However, the number of peripheral nozzle openings 121Sa may be appropriately changed according to design conditions. The plurality of nozzle openings 121S may include a central nozzle opening 121Sb that is surrounded by the peripheral nozzle openings 121Sa.

In this case, the stiffener 130 may be disposed adjacent to the nozzle openings 121S. Because the nozzle opening 121S refers to a part other than the effusion plate 120, the effusion plate 120 that is adjacent to the nozzle opening 121S may be a part that is adjacent to the space, and thus, there is no supported part so that the stiffness may be weakened. The stiffener 130 may be coupled to a portion of the effusion plate 120, which is adjacent to the nozzle opening 121S, to supplement the stiffness of the weak part of the effusion plate 120.

In particular, the stiffeners 130 may be located between the plurality of nozzle openings 121S. Portions located between the plurality of nozzle openings 121S may have a small width because the plurality of nozzle openings 121S are located on opposite sides or around the plurality of nozzle openings 121S. Accordingly, because it corresponds to portions at which the stiffness of the effusion plate 120 is weak, the stiffness may be strengthened by the stiffener 130.

Furthermore, the peripheral portions of the effusion plate 120 may be fixed by other configurations. Accordingly, the peripheral portions of the effusion plate 120 may not have much movement as vibration is transmitted. However, because the portions that are adjacent to the nozzle opening 121S are close to the center of the effusion plate 120, and the center of the effusion plate 120 is not supported by other components, movement is increased by vibration. Accordingly, it may be vulnerable to damage by vibration.

The effusion plate 120 may include a plate part 121, in which the nozzle openings 121S are formed. The plate part 121 may include vulnerable parts 122 that are located between the plurality of nozzle openings 121S. As illustrated in FIG. 4, the stiffener 130 may be located to overlap a portion having the smallest width “w” of the vulnerable part 122 to increase the stiffness of the effusion plate 120. Because the portion of the vulnerable part 122 having the smallest width is not only the weakest and also may be moved with the greatest amplitude to vibration, it may be necessary to supplement by the stiffener 130.

The effusion plate 120 may include a nozzle guide 123 that protrudes from the nozzle opening 121S in a direction that becomes more distant from the nozzle opening 121S to guide the insertion of the nozzle 110. In this case, as illustrated in FIG. 5, the nozzle guide 123 may be formed with a curvature in the plate part 121.

The stiffener 130 may be coupled to the plate part 121 to prevent overlapping with a portion having a curvature of the nozzle guide 123. A portion that is bent while having a curvature by the nozzle guide 123 may be difficult to be coupled to the stiffener 130 due to the curvature thereof. Accordingly, by avoiding this, the stiffener 130 may be coupled to the vulnerable part 122. However, because the stiffness of the vulnerable part 122 may be strengthened as the area of the stiffener 130, which is coupled to the vulnerable part 122, becomes larger, the stiffener 130 may be coupled to the vulnerable part 122 such that a coupling area to the vulnerable part 122 is maximized while avoiding a portion of the nozzle guide 123 having a curvature.

For reference, as illustrated in FIG. 3, the vulnerable part 122 is not formed as being single, but may be provided in plural. The plurality of stiffeners 130 may be provided to correspond to the plurality of vulnerable parts 122, respectively.

A plurality of cooling holes 121H that are formed to move cooling air “A” may be formed in the effusion plate 120. The cooling air “A” may be located in an air chamber 111S formed in the nozzle housing 111 and may flow toward the combustion chamber 140S of the effusion plate 120 through a plurality of cooling holes 121H. The temperature of the combustion chamber 140S is very high, and when the effusion plate 120 directly receives heat by the flames formed in the combustion chamber 140S, the temperature of the effusion plate 120 is raised close to the melting point of the effusion plate 120 due to the flames, and thus the effusion plate 120 may be deformed. In this case, when the cooling air “A” passes through the cooling hole 121H, deformation due to the flames of the effusion plate 120 may be prevented. For reference, a diameter of the cooling hole 121H may be smaller than that of the nozzle opening 121S. When the diameter of the cooling hole 121H is small, the cooling air “A” that passes through the cooling hole 121H may be dispersed along the surface of the effusion plate 120.

To maintain the function of the cooling hole 121H, a stiffener 130 may be configured to prevent the covers of the plurality of cooling holes 121H, as illustrated in FIG. 5. Accordingly, the stiffener 130 may be prevented from interfering with the flow of the cooling air “A” that passes through the plurality of cooling holes 121H.

More specifically, a stiffener hole 130H may be formed in the stiffener 130. In this case, the stiffener hole 130H may be located to communicate with the cooling hole 121H. Furthermore, the stiffener hole 130H may be configured such that a center t hereof overlaps the cooling hole 121H. As illustrated in FIG. 5, the stiffener hole 130H may be configured to have a diameter corresponding to that of the cooling hole 121H.

The stiffener 130 may have a side surface 130a-1 having a curvature corresponding to that of a periphery of the nozzle opening 121S as a side surface 130a-1 that faces the nozzle opening 121S. The stiffener 130 may be adjacent to the nozzle opening 121S, and may be located close to the periphery of the nozzle opening 121S to contact the vulnerable part 122 located between the adjacent nozzle openings 121S as much as possible. To this end, the side surface 130a-1 of the nozzle guide 123 may be formed to be parallel to the periphery of the nozzle opening 121S. That is, because the side surface 130a-1 of the stiffener 130 is a surface that faces the nozzle opening 121S, it may be preferable that it is located close to the nozzle opening 121S. This is the same even when the nozzle guide 123 is formed adjacent to the nozzle opening 121S. In this case, even when the stiffener 130 does not completely contact the nozzle opening 121S by the nozzle guide 123, as illustrated in FIG. 4, the curved portion of the nozzle guide 123 may be formed to have a specific width along the periphery of the nozzle opening 121S so that the side surface 130a-1 of the stiffener 130 may be formed to have a curvature along the periphery of the nozzle opening 121S.

The stiffener 130 may be coupled to a portion of the effusion plate 120, which is located between the nozzles 110 and has a higher temperature than the surroundings. In the above description, it has been described that a thin portion of the effusion plate 120 has a weak stiffness and is vulnerable to vibration, and thus the stiffener 130 is required to supplement this. The effusion plate 120 is also a component to which vibration is transmitted, but at a boundary between the air chamber 111S and the combustion chamber 140S, cracks may occur due to a temperature difference between a side that faces the air chamber 111S and a side that faces the combustion chamber 140S. In this case, a portion of the effusion plate 120 having a large temperature difference may have a high possibility of cracking. It may be said that the temperature of the effusion plate 120 on the side that faces the air chamber 111S is almost similar. However, the temperature of the effusion plate 120 on the side that faces the combustion chamber 140S may vary depending on the aspect of the flames. The stiffener 130 may couple the stiffener 130 to a portion of the effusion plate 120, at which the temperature rises the highest, based on theoretically or empirically acquired information on the temperature increase of the effusion plate 120. In this case, the vulnerable part 122 may mean a part of the effusion plate 120 with a small width, and the small width may mean that there are few objects to receive heat even when the same heat is applied, so that an increase in temperature may increase. Accordingly, the effusion plate 120 may be coupled to the vulnerable part 122.

Furthermore, because the nozzle opening 121S is an area into which at least a portion of the nozzle 110 is inserted, flames may occur in the nozzle opening 121S. Accordingly, a temperature of a portion that is adjacent to the nozzle opening 121S may be the highest. Accordingly, the stiffener 130 may be coupled to the plate part 121 located between the nozzle openings 121S.

In particular, the stiffener 130 may be located to at least partially overlap the area 120S that connects the centers of the peripheral nozzle openings 121Sa and the central nozzle opening 121Sb. Through this, the stiffener 130 may prevent cracks by heat of the effusion plate 120.

In this case, the nozzle 110 may be configured to generate flames on one side of the effusion plate 120. The stiffener 130 may be located on an opposite side that is opposite to the one side of the effusion plate 120. Accordingly, the stiffener 130 may be located in the air chamber 111S to prevent deformation due to heat. Furthermore, it is possible to prevent a combustion efficiency from being affected by not affecting the shape of the effusion plate 120 toward the combustion chamber 140S determined to improve the efficiency of the combustion chamber 140S.

The stiffener 130 may be provided to be coupled to the effusion plate 120 during the initial release of the power generator 1, or may be provided to be attached to the effusion plate 120 when the effusion plate 120 is repaired during a repair inspection of the power generator 1. Accordingly, when a crack has already occurred in the effusion plate 120, the stiffener 130 may be combined with the cracked part to provide the effusion plate 120.

The stiffener 130 may be first coupled to the effusion plate 120 without the stiffener hole 130H being provided. In this case, the stiffener 130 and the effusion plate 120 may be coupled through intermittent welding or brazing. Thereafter, the stiffener hole 130H may be formed in correspondence to the position, in which the cooling hole 121H is formed.

Hereinafter, an aspect that is different from the first aspect will be described. Contents that are common to those of the first aspect will be omitted as much as possible, and other aspects will be described. That is, it is apparent that contents that are not described in other aspects may be supplemented through the contents of the first aspect when necessary.

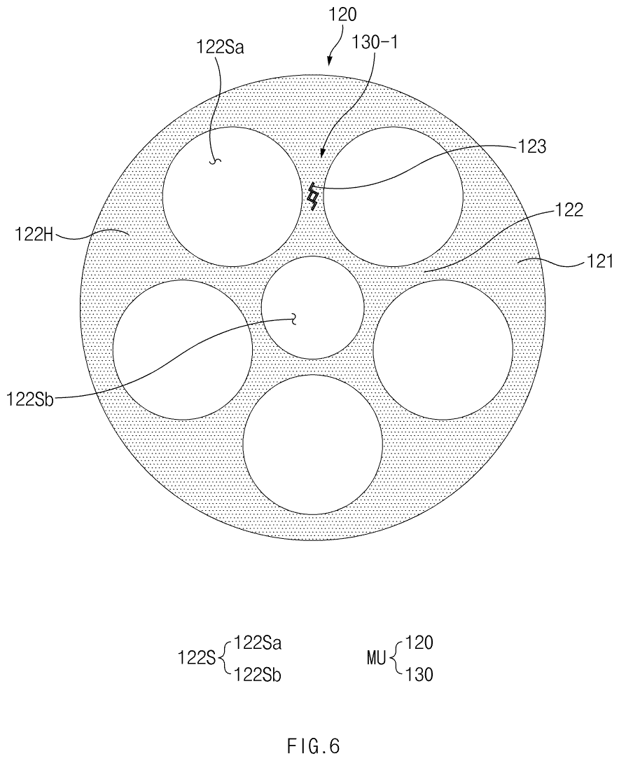

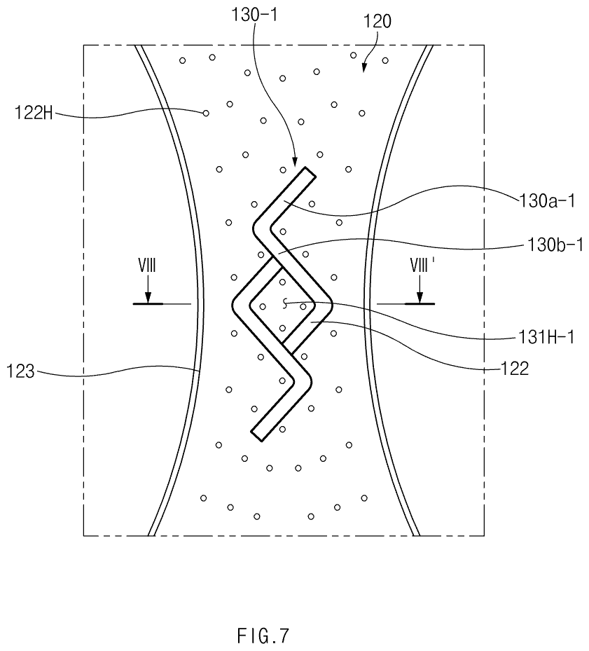

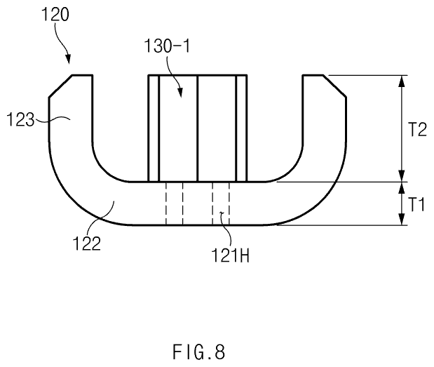

FIG. 6 is a plan view as viewed from a rear side of the effusion plate 120 and a stiffener 130-1 according to a second aspect of the present disclosure. FIG. 7 is an enlarged plan view illustrating the effusion plate 120 and the stiffener 130-1 illustrated in FIG. 6, focusing on the stiffener 130-1. FIG. 8 is a cross-sectional view taken along line VIII-VIII′ illustrated in FIG. 7.

Referring to FIGS. 6 to 8, the stiffener 130-1 according to the second aspect of the present disclosure will be described.

The second aspect is different from the first aspect in that the shape of the stiffener 130-1 is different.

As illustrated in FIG. 7, the stiffener 130-1 may include a first stiffener 131 and a second stiffener 132. The first stiffener 131 and the second stiffener 132 may be coupled to each other. A spacing hole 131H-1 may be formed between the first stiffener 131 and the second stiffener 132. In other words, the stiffener 130-1 may have a spacing hole 131H-1 therebetween to dissipate the heat of the effusion plate 120 and may protrude from the effusion plate 120.

As illustrated in FIG. 8, the stiffener 130-1 may have a thickness T2 that is greater than a thickness T1 of the effusion plate 120. That is, the stiffener 130-1 may further protrude than the thickness T1 of the effusion plate 120. The stiffener 130-1 may protrude toward the air chamber 111S. Accordingly, the heat of the effusion plate 120 may be transferred to the air chamber 111S through the stiffener 130-1. That is, the stiffener 130-1 may help to cool the effusion plate 120. Like an air cooling device having fin shapes, the stiffener 130-1 may help cool the effusion plate 120.

The stiffener 130-1 may include a first stiffener part 130a that extends in a first direction, and a second stiffener part 130b that extends from the first stiffener part 130a and extends in a second direction that is different from the first direction. Furthermore, the stiffener 130-1 may have an “S” shape. Furthermore, as illustrated in FIG. 7, each of the first stiffener 131 and the second stiffener 132 may be provided in an “S” shape. Through this, a surface area of the stiffener 130-1 is increased to further help to cool the effusion plate 120.

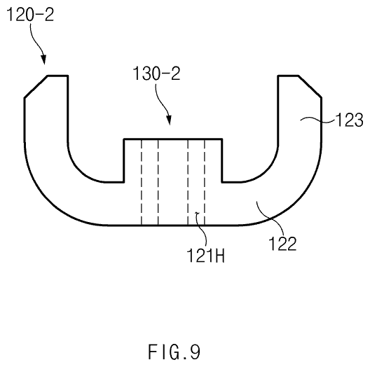

FIG. 9 is a longitudinal cross-sectional view of a part of the effusion plate 120 and a stiffener 130-2 according to a third aspect of the present disclosure.

Referring to FIG. 9, the stiffener 130-2 according to the third aspect of the present disclosure will be described.

The third aspect is different from the first aspect in that the effusion plate 120 and the stiffener 130-2 are integrally formed.

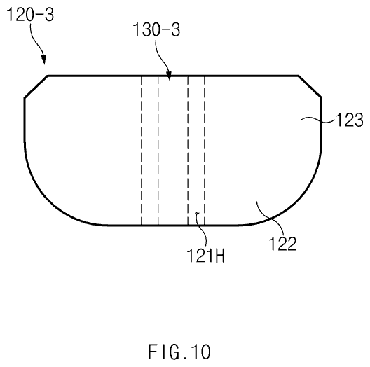

FIG. 10 is a longitudinal cross-sectional view of a part of the effusion plate 120 and a stiffener 130-3 according to a fourth aspect of the present disclosure.

The fourth aspect is different from the first aspect in that the nozzle guide 123 is not distinguished from the stiffener 130-3.

According to an aspect of the present disclosure, the stiffener coupled to the effusion plate may be included so that damage to the effusion plate due to flame vibration may be prevented by changing the natural frequency of the effusion plate.

According to an aspect of the present disclosure, the stiffness of the effusion plate may be supplemented by coupling the stiffener to the weak portion of the effusion plate having a small width.

According to an aspect of the present disclosure, degradation of the cooling performance of the effusion plate may be prevented by coupling the cooling hole of the effusion plate to the stiffener that is not covered.

According to an aspect of the present disclosure, the heat of the effusion plate may be emitted through the stiffener by providing the stiffener that protrudes from the effusion plate.

In the meantime, effects obtained in aspects of the present disclosure are not limited to the above-mentioned effects, and other effects that are not mentioned will be clearly understood by those skilled in the art from the following description.

Unless explicitly stated, the aspects described above may be combined with other aspects. Alternatively, it may be considered that combinations of the aspects are possible, unless one aspects is explicitly limited in combination with another aspects. It is considered that any combination of any of the aspects herein is disclosed in this document.

Although the present disclosure has been described above by means of limited aspects and drawings, aspects of the present disclosure is not limited thereto, and various aspects are possible within the scope that is equivalent to the technical idea of aspects of the present disclosure and the scope of the patent claims to be described below by a person skilled in the art, to which the present disclosure pertains.

What is claimed is:

1. A combustor comprising:
a nozzle configured to generate flames;
an effusion plate, in which at least a portion of the nozzle is accommodated; and
a stiffener coupled to the effusion plate to change a natural frequency of the effusion plate.

2. The combustor of claim 1, wherein a nozzle opening configured such that the nozzle is inserted thereinto is formed in the effusion plate, and
wherein the stiffener is located adjacent to the nozzle opening.

3. The combustor of claim 2, wherein a plurality of nozzle openings is provided, and
wherein the stiffeners are located between the plurality of nozzle openings.

4. The combustor of claim 3, wherein the plurality of nozzle openings includes peripheral nozzle openings arranged in a circumferential direction, and
wherein the stiffeners are located between the peripheral nozzle openings.

5. The combustor of claim 3, wherein the effusion plate includes a vulnerable parts located between the plurality of nozzle openings, and
wherein the stiffeners are located to overlap a portion of the vulnerable part, which has the smallest width, to increase a stiffness of the effusion plate.

6. The combustor of claim 2, wherein the effusion plate includes:
a plate part, in which the nozzle opening is formed; and
a nozzle guide protruding from the nozzle opening in a direction becoming more distant from the nozzle opening to guide insertion of the nozzle,
wherein the nozzle guide is formed to be bent from the plate part while having a curvature, and
wherein the stiffener is coupled to the plate part to prevent from overlapping a portion of the nozzle guide, which has the curvature.

7. The combustor of claim 1, wherein a plurality of cooling holes formed such that cooling air flows therethrough is formed in the effusion plate, and
wherein the stiffener is configured to prevent the plurality of cooling holes from being covered.

8. The combustor of claim 7, wherein a stiffener hole is formed in the stiffener, and
wherein the stiffener hole is located to communicate with the cooling hole.

9. The combustor of claim 2, wherein the stiffener has a side surface facing the nozzle opening and having a curvature corresponding to a curvature of a periphery of the nozzle opening.

10. The combustor of claim 1, wherein the stiffener protrudes from the effusion plate while having a spacing hole between the effusion plate and the stiffener to emit heat of the effusion plate.

11. The combustor of claim 10, wherein the stiffener protrudes longer than a thickness of the effusion plate.

12. The combustor of claim 1, wherein the stiffener includes:
a first stiffener part extending in a first direction; and
a second stiffener part extending from the first stiffener part, and extending in a second direction being different from the first direction.

13. The combustor of claim 10, wherein the stiffener is located between the nozzles and is coupled to a portion of the effusion plate, which has a higher temperature than that of a surrounding.

14. The combustor of claim 3, wherein the plurality of nozzle openings include:
peripheral nozzle openings arranged in a circumferential direction; and
a central nozzle opening surrounded by the peripheral nozzle openings, and
wherein the stiffener is located such that at least a portion thereof overlaps an area obtained by connecting centers of the peripheral nozzle openings and the central nozzle opening.

15. The combustor of claim 1, wherein the nozzle is configured to generate the flames on one side of the effusion plate, and
wherein the stiffener is located on an opposite side of the effusion plate, which is opposite to the one side.

16. A power generator comprising:
a combustor; and
a turbine configured to generate electricity by a gas burned in the combustor,
wherein the combustor includes:
a nozzle configured to generate flames;
an effusion plate, on which the nozzle is mounted; and
a stiffener coupled to the effusion plate to change a natural frequency of the effusion plate.

17. The power generator of claim 16, wherein a nozzle opening configured such that the nozzle is inserted thereinto is formed in the effusion plate, and
wherein the stiffener is located adjacent to the nozzle opening.

18. The power generator of claim 17, wherein a plurality of nozzle openings is provided, and
wherein the stiffeners are located between the plurality of nozzle openings.

19. The power generator of claim 17, wherein the plurality of nozzle openings includes peripheral nozzle openings arranged in a circumferential direction, and
wherein the stiffeners are located between the peripheral nozzle openings.

20. A combustor comprising:
a nozzle housing defining an air chamber, into which air is introduced from a compressor, and in which a nozzle is accommodated;
a combustor housing defining a combustion chamber, in which a combustion reaction occurs;
an effusion plate dividing the air chamber and the combustion chamber; and
a stiffener coupled to the effusion plate to change a natural frequency of the effusion plate.
